(19) United States
(12) Patent Application Publication
(10) Pub. No.: US 2015/0289548 A1
(43) Pub. Date: Oct. 15, 2015

(54) METHOD TO IMPROVE DISPERSIBILITY OF A MATERIAL HAVING LOW SOLUBILITY IN WATER

(71) Applicant: PEPSICO, INC., Purchase, NY (US)

(72) Inventors: Peter S. Given, Ridgefield, CT (US); Daniela White, Ridgefield, CT (US)

(21) Appl. No.: 14/438,680

(22) PCT Filed: Oct. 28, 2013
(86) PCT No.: PCT/US2013/067012

§ 371 Date: Apr. 27, 2015

Related U.S. Application Data
(60) Provisional application No. 61/726,271, filed on Nov. 14, 2012.

(51) Int. Cl. A23L 1/221; A23L 2/60; A23L 1/09

(52) U.S. Cl. CPC A23L 1/221; A23L 1/09; A23L 2/60; A23V 2002/00

(57) ABSTRACT

Co-precipitates of a water insoluble food ingredient material and a hydrophilic polymer, and edible aqueous microdispersions of such co-precipitates are provided. The water insoluble food ingredient material may include rebaudioside D and the hydrophilic polymer may include carboxymethyl cellulose. Methods of making co-precipitates of a water insoluble food ingredient material and a hydrophilic polymer are provided.

### CROSS-REFERENCE TO RELATED APPLICATIONS

This application claims the benefit of U.S. provisional patent application Ser. No. 61/726,271, filed Nov. 14, 2012, and titled “Method to Improve Dispersibility of a Material Having Low Solubility in Water,” which application is incorporated by reference herein.

### FIELD

Aspects of the disclosure generally relate to a method for improving the dispersibility of a material having a low solubility in water. More specifically, a method is described for improving the dispersibility of rebaudioside D.

### BACKGROUND

Steviol glycosides are sweet-tasting compounds extracted from the stevia plant (Stevia rebaudiana Berton). In a crude stevia extract these compounds typically are found to include stevioside, steviolbioside, several rebaudiosides, including rebaudioside A (Reb A), rebaudioside B (Reb B), rebaudioside C (Reb C), rebaudioside D (Reb D), and rebaudioside E (Reb E), and dulcoside compounds. Much development work has been done on methods and systems for purifying crude stevia extracts to yield sweetener products high in stevioside, rebaudioside A or both, each of which is present in relatively higher amounts in a typical stevia extract. Several others of the extract compounds, including rebaudioside D, are found to typically be present only in trace amounts and have often been treated as impurities or contaminants to be removed in the production of a stevia sweetener.

Steviol glycosides are found in the leaves of the stevia plant and each have a particular taste profile and sweetness intensity. Since receiving GRAS status, rebaudioside A has become a popular naturally occurring potent sweetener in the food and beverage industry. Rebaudioside A is approximately 200 times sweeter than sucrose, but the sweetness may be offset by problems of off-tastes, for example slow on-set, or bitter, licorice, or lingering aftertaste. Rebaudioside D is one of the other sweet steviol glycosides and has a sweetness intensity similar to rebaudioside A, but possesses a more desirable taste profile than many of the other steviol glycosides, including rebaudioside A, stevioside, rebaudioside C, rebaudioside E, and dulcoside A. Unfortunately, the water solubility of commercially available rebaudioside D is low. This leads to difficulties in making certain rebaudioside D sweetened products, e.g., carbonated beverages, using traditional bottling process methods.

Traditionally, the beverage industry makes certain carbonated beverages by first making concentrated syrup and then diluting the syrup with water at the time and place of making the beverage. The dilution ratio in such beverages is often 1:5; meaning one part syrup is mixed with five parts water. The beverage often is carbonated at the time of being bottled or otherwise packaged. For any ingredient to be incorporated into such a 1:5 syrup, the solubility of the ingredient in the syrup must be at least six times higher than its desired concentration in the finished beverage. Therefore, when comparing the solubility of compounds such as stevioside (which is found to be only sparingly soluble in water) to rebaudioside A (which contains an additional glucose unit on its structure), rebaudioside A is found to be more soluble than stevioside. The solubility of rebaudioside A in aqueous solution at room temperature is at least 3000 ppm, enabling the production of a beverage (e.g., carbonated beverage, juice beverage, energy drink, and the like) with a concentration of about 500 ppm of rebaudioside A. In contrast, the stable solubility of rebaudioside D in aqueous solution at room temperature has been found to be no more than about 450 ppm at typical “cold fill” beverage processing conditions, yielding a beverage containing only about 74 ppm of rebaudioside D. For many beverages, this concentration does not yield a sufficiently effective level of sweet taste to the beverage. It would be advantageous, therefore, to develop improved methods of incorporating rebaudioside D into an aqueous solution.

Accordingly, it is an object of some aspects of the present disclosure to provide microdispersions of materials having low solubility in water, such as, rebaudioside D, as well as syrups, solutions, beverages, sweeteners, compositions and other products comprising the new microdispersions of material having low water solubility, optionally alone or with other ingredients, e.g., nutritive, non-nutritive, natural and/or artificial sweeteners, bulking agents, etc. Additional objects, features and advantages of all or certain embodiments of the systems and methods disclosed here will be apparent to those skilled in the art given the benefit of the following disclosure and discussion of various exemplary embodiments.

### BRIEF SUMMARY

The following presents a simplified summary of aspects of the inventive sweeteners, syrups, solutions, beverages, components, products, compositions and methods disclosed here. This summary is not an extensive overview, and it is not intended to identify all or only key or critical elements or to delineate the scope of the inventive sweeteners, syrups, solutions, beverages, components, products, compositions and methods covered by the claims. The following summary merely presents some concepts and aspects of the disclosure in a simplified form as a prelude to the more detailed description provided below of certain exemplary and non-limiting embodiments of the invention.

In accordance with a first aspect of the invention an edible aqueous microdispersion comprising a precipitate material, or in some aspects a co-precipitate material, comprising a hydrophilic polymer and a low solubility material. The low solubility material may be a food ingredient material. The precipitate material is present in the aqueous dispersion at a concentration sufficient to provide an effective concentration of the low solubility material that is higher than the normal solubility of the low-solubility material in water at standard temperature and pressure. The low solubility material has a perceptible taste in the aqueous microdispersion.

In certain embodiments the low solubility material is a natural low solubility material. In some embodiments, the low solubility material is a sweetener, and in certain embodiments is a nutritive sweetener, natural sweetener, and/or a potent sweetener. In some embodiments, the low solubility material comprises rebaudioside D (e.g., a sweetening amount of rebaudioside D), and in some aspects, further comprises a sweetening amount of rebaudioside A, rebaudioside B, rebaudioside C, rebaudioside E, rebaudioside F, mogroside, stevioside, steviol glycoside, Lo Han Guo, or a combination of any of them. In some embodiments, the microdispersion further comprises a flavor, a flavonoid, a flavonol, a flavanone, a flavone, an isoflavone, a stilbene (e.g., resveratrol), a polyphenol (e.g., catechin), a hydroxybenzoic acid, a bioactive, a taste modifier, an alkaloid, an anthocyanin, a coumarin, a chromone, a chalcone or a combination of any of them.

In certain embodiments, the hydrophilic polymer is a natural hydrophilic polymer. In some embodiments, the hydrophilic polymer is a food-grade synthetic polymer. In some embodiments the hydrophilic material comprises starch, amylose, amylopectin, protein, collagen, casein, carboxymethyl cellulose, alpha-lactoglobulin, beta-lactoglobulin, alpha-lactalbumin, gelatin, mucin, bromelain, polysaccharide, gum, alginate, carrageenan, gum arabic, locus bean gum, guar gum, pectin, maltodextrin, xanthan gum, or a combination of any of them. In certain embodiments, the hydrophilic polymer comprises carboxymethyl cellulose. In certain embodiments, the low solubility material comprises rebaudioside D and the hydrophilic polymer comprises carboxymethyl cellulose.

In certain embodiments, the low solubility material has a water solubility of one part material to 100-1,000 parts solvent. In some embodiments, the solution of the low solubility material comprises at least 50% ethanol. In certain embodiments, the ethanol is removed from a hydrophilic polymer and low solubility material solution. In certain embodiments, the aqueous microdispersion of precipitate material comprises from 0.01% to 5.0% precipitate material. In some embodiments, the precipitate material mean particle size is from 2.0 μm to 15.0 μm. In some embodiments, an aqueous dispersion of precipitate material comprises a flavor, a flavonoid, a flavonol, a flavanone, a flavone, an isoflavone, a stilbene (e.g., resveratrol), a polyphenol (e.g., catechin), a hydroxybenzoic acid, a bioactive, a taste modifier, an alkaloid, an anthocyanin, a coumarin, a chromone, a chalcone or a combination of one or more of any of them. In certain embodiments, the aqueous microdispersion of a precipitate material is added to an edible composition.

In accordance with a second aspect of the invention, a method of forming an aqueous microdispersion of a precipitate material comprising a hydrophilic polymer and a low solubility material is provided. The method comprises providing a solution of a low solubility material, providing a solution of hydrophilic polymer, combining the solution of low solubility material and the solution of hydrophilic polymer to form a hydrophilic polymer and low solubility material solution. The low solubility material co-precipitates with the hydrophilic polymer and stabilizes by hydrogen bonding.

In accordance with another aspect of the invention, an edible aqueous microdispersion of a low solubility material is formed by a method comprising providing a solution of low solubility material comprising as solvent a mixture of at least water and an alcohol, providing a solution of hydrophilic polymer, combining the solution of low solubility material and the solution of hydrophilic polymer to form a hydrophilic polymer and low solubility material solution. The low solubility material co-precipitates with the hydrophilic polymer and stabilizes by hydrogen bonding.

In accordance with another aspect of the invention, an edible composition comprises a sweetener. The edible composition is prepared by a method comprising providing a solution of a sweetener comprising as solvent a mixture of at least water and an alcohol; providing a solution of a water-soluble hydrophilic polymer; combining the solution of the sweetener and the solution of the hydrophilic polymer to form a hydrophilic polymer and sweetener solution; allowing the sweetener to co-precipitate with the hydrophilic polymer; and adding the co-precipitate to an edible composition.

In accordance with another aspect of the invention, a method for forming an aqueous microdispersion of rebaudioside D is provided. The method comprises providing a solution of rebaudioside D comprising as solvent a mixture of water and at least 50% ethanol, providing a solution of carboxymethyl cellulose, combining the solution of rebaudioside D and the solution of carboxymethyl cellulose to form a rebaudioside D and carboxymethyl cellulose solution, allowing the rebaudioside D to co-precipitate with the carboxymethyl cellulose.

In accordance with another aspect of the invention, a precipitate is provided comprising a low solubility material and a hydrophilic polymer. The low solubility material has a normal solubility value of 1 part material to 100-1,000 parts solvent. In certain aspects, the precipitate is a co-precipitate. In some embodiments, the precipitate is spray dried.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 is a diagram illustrating the spray-dry process of a Reb D microdispersion.

FIG. 2 summarizes the comparative particle size data of Reb D co-precipitated with a variety of hydrophilic polymers.

FIG. 3 is a microscopic image of a microdispersion of Reb D co-precipitated with carboxymethyl cellulose (CMC).

FIG. 4 is a microscopic image of a microdispersion of Reb D precipitated from a solution having no polymer.

FIG. 5 is a microscopic image of a microdispersion of Reb D co-precipitated with 1% poly (vinyl alcohol).

### DETAILED DESCRIPTION

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are merely non-limiting examples of the inventive subject matter, and there are alternative embodiments which are not excluded. Unless otherwise indicated or unless otherwise clear from the context in which it is described, alternative and optional elements or features in any of the disclosed embodiments and examples are interchangeable with each other. That is, an element described in one embodiment or example should be understood to be interchangeable or substitutable for one or more corresponding but different elements in another described example or embodiment and, likewise, an optional feature of one embodiment or example may optionally also be used in other embodiments and examples. More generally, the elements and features of any disclosed example or embodiment should be understood to be disclosed generally for use with other aspects and other examples and embodiments. A reference to a component or ingredient being operative or configured to perform one or more specified functions, tasks, and/or operations or the like, is intended to mean that it can perform such function(s), task(s), and/or operation(s) in at least certain embodiments, and may well be able to perform one or more other functions, tasks, and/or operations. While this disclosure mentions specific examples and embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited in the claim. The phrase “consisting essentially of” is used to signal that the product or process defined necessarily includes the listed ingredients and is open to unlisted ingredients that do not materially affect the basic and novel properties of the invention.

As used in this disclosure, unless otherwise specified, the term “dispersion” means a system comprising particles of a material dispersed in a dispersant or dispersing agent. A “dispersing agent” refers to a substance that promotes the formation and stabilization of a dispersion of one substance in another. As used here, a dispersing agent may be a hydrophilic polymer. The term “microdispersion,” as used here, means a dispersion in which the dispersed phase comprises relatively small particles, specifically particles in the micron size range.

Certain aspects of this disclosure relate to “solubility,” which is defined in a broad sense as the ability or tendency of one substance to dissolve in or into another. “The solubility” of a material may also be expressed as the greatest amount of material that will dissolve in a specified volume of solvent under particular conditions. The solubility of a material may be total or fractional and varies depending on the physico-chemical characteristics of the solvent in which it is incorporated (e.g., temperature, pressure, pH, etc). Solvents suitable for use in certain embodiments disclosed here include, without limitation, water, alcohols (e.g., benzyl alcohol, methanol, ethanol, and isopropanol), citric acid, propylene glycol, glycerine, triacetin, limonene, suitable hydrocarbons, suitable substituted hydrocarbons, amines, aldehydes, esters, ketones, lactones, phenols, acids, nitrogen- and sulfur-containing compounds, and mixtures of any of them. As described here, a material's “normal solubility” is the solubility of the material in water at standard temperature and pressure (STP). As described here, a material described as having “low solubility” is a material that does not significantly dissolve in water under standard conditions, i.e., is not soluble at high enough concentration to provide desired product sensory attributes.

Certain aspects of this disclosure relate to the “concentration” of a solution, which is taken to mean the amount of solute in a given amount of solvent or solution. There are many ways to express concentration. For example, concentration may be defined in units of mass per unit volume (e.g., mg/mL, mg/cm³ and the like), percent by mass (which is simply the mass of the solute divided by the total mass of the solution multiplied by 100% (e.g., weight percent, percent by weight, wt. %, w/w, and the like)), percent by volume (which is simply the volume of the solute divided by the sum of the volumes of the other components multiplied by 100% (e.g., volume percent, percent by volume, v/v, and the like)), molarity (which is the number of moles of solute dissolved in one liter of solution), molality (which is the number of moles of solute dissolved in one kilogram of solvent), and parts per million (which is defined as the mass of the component in solution divided by the total mass of the solution multiplied by 10⁶ (e.g., ppm)). A “saturated” solution is a solution in which the concentration of dissolved solute is equal to that which would be in equilibrium with un-dissolved solute under the given conditions, e.g., temperature and pressure. As referred to here, an “effective concentration” of a material should be understood to mean the amount of material necessary to provide an identifiable effect in an aqueous microdispersion. For example, an effective concentration of a sweetener would be the amount of sweetener necessary to provide a discernable sweetening taste to an aqueous microdispersion. A “sweetening amount” of a sweetener would be the amount of sweetener, which provides sweetness to an edible composition, i.e., which is perceived as sweet by the sense of taste.

As used here and in the appended claims “aqueous solution” is defined as any solution in which water is all or some of the dissolving medium or solvent. The solution may optionally, in addition to water, comprise other liquids in varying amounts. In some embodiments of the methods disclosed here, the aqueous solution comprises at least 50% by weight water, at least 75% by weight water, at least 90% by weight water, or at least 95% by weight water.

In at least certain embodiments of the invention, a “supersaturated aqueous solution” disclosed here and in the appended claims may include a material having low water solubility, such as, for example, rebaudioside D. A “supersaturated aqueous solution” refers to an aqueous solution that contains more of the dissolved material than could be achieved by mixing the material alone in water at standard conditions, typically attained by dissolving as much substrate as possible at elevated temperature, followed by cooling to room temperature. In other words, the aqueous solution contains an amount of the material greater than the amount of material required for saturation at standard conditions, as a result of having been stabilized by hydrogen bonding with a hydrophilic polymer. Certain embodiments of the methods disclosed here comprise forming supersaturated aqueous solutions of a material having low water solubility, such as, for example, rebaudioside D, at concentrations of at least 500 ppm, at least 1,000 ppm, at least 1,500 ppm, at least 2,000 ppm, at least 2,500 ppm, at least 3,000 ppm, at least 5,000 ppm, or at least 10,000 ppm, but no more than 50,000 ppm.

It is desirable to incorporate a low solubility material into an edible composition, such as, for example, a sweetener composition, a syrup, a beverage concentrate, a food product, a beverage product, etc. In some aspects, the low solubility material may be a low solubility food ingredient material. In one embodiment of the invention, a precipitate material comprising a low solubility material and a hydrophilic polymer is incorporated into an edible composition by producing an edible aqueous microdispersion of the precipitate material and incorporating it into an edible composition. In alternative embodiments, a precipitate material comprising a low solubility material and a hydrophilic polymer is incorporated into an edible composition by spray-drying a precipitate material and incorporating it into an edible composition. In some embodiments, the low solubility material (also referred to here as low water solubility material) may comprise any material that requires 30-10,000 parts, 30-1,000 parts, 100-10,000 parts, or 100-1,000 parts solvent to dissolve 1 part of the low solubility material. Such solubility should be tested in a pH range of 1.2 (0.1N HCl) to 7.5 at standard temperature and pressure (STP). As defined by the US Pharmacopeia, a material requiring 30 to 100 parts solvent to dissolve 1 part material is classified as “sparingly soluble”; a material requiring 100 to 1,000 parts solvent to dissolve 1 part material is classified as “slightly soluble”; a material requiring 1,000 to 10,000 parts solvent to dissolve 1 part material is classified as “very slightly soluble”; and a material requiring more than 10,000 parts solvent to dissolve 1 part material may be classified as “practically insoluble”.

In certain embodiments, the low solubility food ingredient material is a sweetener. The sweetener may include, but is not limited to, nutritive, non-nutritive, natural, artificial, synthetic, potent, and any combination thereof. The term “nutritive sweetener” refers generally to sweeteners which provide significant caloric content in typical usage amounts, e.g., more than about 5 calories per 8 oz. serving of beverage. As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage sweetened to a level of 10 degrees Brix with sugar. Potent sweeteners include both nutritive (e.g., Lo Han Guo juice concentrate) and non-nutritive sweeteners (e.g., typically, Lo Han Guo powder). In addition, potent sweeteners include both natural potent sweeteners (e.g., steviol glycosides, Lo Han Guo, etc.) and artificial potent sweeteners (e.g., neotame, etc.). However, for natural beverage products, only natural sweeteners are employed, such as, for example, natural potent sweeteners. Commonly accepted potency figures for certain potent sweeteners include, for example,

| | |
|---|---|
| Cyclamate | 30 times as sweet as sugar |
| Stevioside | 100-250 times as sweet as sugar |
| Mogroside V | 100-300 times as sweet as sugar |
| Rebaudioside A | 150-300 times as sweet as sugar |
| Acesulfame-K | 200 times as sweet as sugar |
| Aspertame | 200 times as sweet as sugar |
| Saccharine | 300 times as sweet as sugar |
| Neohesperidin dihydrochalcone | 300 times as sweet as sugar |
| Sucralose | 600 times as sweet as sugar |
| Neotame | 8,000 times as sweet as sugar |
| Rebaudioside D | 180-200 times as sweet as sugar |

As used herein, a “non-nutritive sweetener” is one which does not provide significant caloric content in typical usage amounts, i.e., is one which imparts less than 5 calories per 8 oz. serving of an edible composition to achieve the sweetness equivalent of 10 Brix of sugar. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz. serving of beverage. As used herein, “zero-calorie” or “diet” means having less than 5 calories per serving, e.g., per 8 oz., for beverages.

Natural embodiments of the beverage products disclosed here are natural in that they do not contain anything artificial or synthetic (including any color additives regardless of source) that would not normally be expected to be in the food. As used herein, therefore, a “natural” edible composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately.

Non-limiting examples of a low solubility material include, for example, rebaudioside A, rebaudioside B, rebaudioside C, rebaudioside D, rebaudioside E, rebaudioside F, steviosides, steviol glycosides, mogrosides, Lo Han Guo, flavors, flavonoids, flavonols, flavanones, flavones, isoflavones, stilbenes (e.g., resveratrol), polyphenols (e.g., catechin), hydroxybenzoic acids, bioactives, taste modifiers, alkaloids, anthocyanins, coumarins, chromones, chalcones, and combinations of any of them. In certain embodiments, the low solubility material is rebaudioside D and, in some aspects, can include stevioside, other steviol glycosides in addition to rebaudioside D, or related compounds or mixtures of any of them for sweetening. These compounds, including rebaudioside D, can be obtained by extraction or the like from the stevia plant. Stevia (e.g., Stevia rebaudiana Bertoni) is a sweet-tasting plant. The leaves contain a complex mixture of natural sweet diterpene glycosides. The following non-sweet constituents also have been identified in the leaves of stevia plants: labdane, diterpene, triterpenes, sterols, flavonoids, volatile oil constituents, pigments, gums and inorganic matter. Without being bound by theory, it is believed that rebaudioside D forms one or more hydrate(s) during its manufacturing process and the hydrate(s) function to inhibit the water solubility of rebaudioside D. Table 1 illustrates elemental analysis that indicates the formation of a tri-hydrate in commercially available rebaudioside D compound.

TABLE 1

| Theoretical Values for | | Theoretical Values for |
|---|---|---|
| Anhydrous Reb D | | Reb D Trihydrate |
| C₅₀H₈₀O₂₈ | Found Values | C₅₀H₈₀O₂₈•3H₂O |
| C: 53.19% | C: 50.14%; 50.24% | C: 50.76% |
| H: 7.09% | H: 7.08%; 7.23% | H: 7.28% |
| O: 39.72% | O: 42.13%; 42.32% | O: 41.96% |

In certain embodiments, the low solubility material is dissolved in a solvent such as an alcohol liquid, or alternatively, an alcohol liquid and water blend, propylene glycol, and propylene glycol and water blend. The alcohol in the alcohol liquid is any organic compound suitable for a room temperature alcohol liquid, in which a hydroxyl functional group is bound to a carbon atom. In certain embodiments the alcohol liquid may comprise alcohol molecules diluted within the alcohol liquid. In alternative embodiments the alcohol liquid may be a pure alcohol. The alcohol liquid may comprise, for example, various amounts of alcohol molecules, including 50 wt. %, 60 wt. %, 70 wt. %, 80 wt. %, 90 wt. %, or 100 wt. % alcohol molecules. For example, an “alcohol liquid” consisting essentially of ethanol could have approximately 95 wt. % ethanol molecules and 5 wt. % water molecules. Denatured ethanol has a higher percentage of ethanol molecules, but typically includes benzene or other inedible content. In some embodiments, the solvent may be an alcohol liquid such as, for example, benzyl alcohol, ethanol, or isopropanol. In certain embodiments, the low solubility material may be dissolved in a water-ethanol solvent to form a solution of low solubility material. In some embodiments, the water-ethanol solvent ratio is 0:100, 25:75, 50:50, 75:25, or 100:0 water to ethanol. The water-ethanol solvent solution is at least 5%, at least 25%, at least 50%, at least 75%, at least 95%, or at least 100% ethanol. In alternative embodiments, the low solubility material may be dissolved in a water-propylene glycol solvent to form a solution of low solubility material. In some embodiments, the water-propylene glycol solvent ratio is 0:100, 25:75, 50:50, 75:25, or 100:0 water to propylene glycol. The water-propylene glycol solvent solution is at least 5%, at least 25%, at least 50%, at least 75%, at least 95%, or at least 100% propylene glycol. In some embodiments, a 0.1% to 10.0%, 0.5% to 5.0%, or about 1% low solubility material solution is provided.

In certain embodiments, the solution of low solubility material is heated to a temperature within the range of 50° C. to 75° C. In certain embodiments, the solution of low solubility material is heated to a temperature of about 65° C. In some embodiments, while heating, the solution of low solubility material is stirred, in certain embodiments vigorously stirred, on a stir plate. In some embodiments, the solution may be heated and stirred for 5 to 30 minutes. In certain embodiments, the solution may be heated and stirred for at least 10 minutes at a rate sufficient to keep the low solubility material mobile during dissolution. The stirring rate of the solution is at a rate such that enough turbulence is generated to keep the solution mobile. In certain embodiments, the solution is heated and stirred until the solution is optically, i.e., visually, a clear solution. In certain embodiments, the clear solution will be a clear supersaturated solution. The temperature range for heating the material and the time required for heat treatment will depend, in part, on the type of low solubility material. It will be within the ability of those skilled in the art, given the benefit of this disclosure, to select a suitable temperature for heating the low solubility material and time required for heating of the low solubility material for any particular embodiment of the beverage products disclosed here.

After heating and stirring the solution of low solubility material, the solution is, in certain embodiments, cooled to room temperature while undergoing continued stirring. Room temperature, as used here, is a temperature within the range of 20° C. to 25° C. In certain embodiments, a polymer solution is added to the solution of low solubility material forming a polymer and low solubility material solution. In some embodiments, the polymer solution comprises a hydrophilic polymer, and in certain embodiments comprises a natural hydrophilic polymer. In some embodiments, a hydrophilic polymer may be a food-grade synthetic polymer. Non-limiting examples of a hydrophilic polymer include, for example, starches (e.g. amylose, amylopectin), proteins, collagen, casein, carboxymethyl cellulose, alpha-lactoglobulin, beta-lactoglobulin, alpha-lactalbumin, gelatin, mucin, bromelain, polysaccharides and gums, alginates, carrageenan, gum arabic, locus bean gum, guar gum, pectin, maltodextrin, xanthan gum, and combinations of any of them. In certain embodiments, the polymer solution comprises carboxymethyl cellulose. In some embodiments, the polymer solution is a 1% polymer solution. In alternative embodiments, the polymer solution is a 1% to 30% polymer solution, a 1% to 20% polymer solution, a 2% to 10% polymer solution, or a 2% to 5% polymer solution. In certain embodiments, a solution of carboxymethyl cellulose is added to a solution of rebaudioside D.

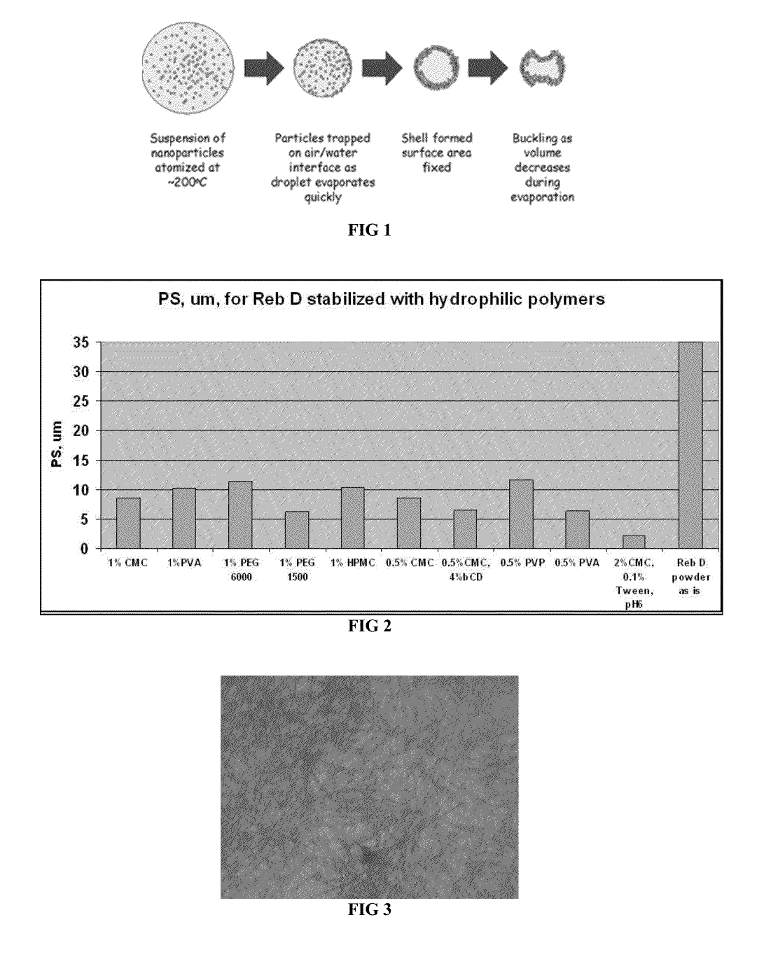

In certain embodiments, a hydrophilic polymer and low solubility material solution is kept overnight during which time any remaining ethanol will evaporate. Upon evaporation trace amounts of ethanol may remain in solution, but in most embodiments, such trace amounts of ethanol will be negligible. In alternative embodiments, any remaining ethanol is removed from the hydrophilic polymer and low solubility material solution under vacuum, such as by using a rotavap. In another embodiment, the hydrophilic polymer and low solubility material solution is spray-dried. An exemplary spray-drying process is depicted in FIG. 1.

It is presently understood that the low solubility material co-precipitates with the hydrophilic material thereby forming a precipitate material. The phrase “co-precipitate” refers to the complexes (also referred to here as particles) of low solubility material, such as rebaudioside D, stabilized by a hydrophilic polymer, such as carboxymethyl cellulose. A co-precipitate may be understood to be a complex of a low solubility material hydrogen bonded to at least one chain of a hydrophilic polymer. It is currently understood that the hydrophilic polymer forms polymer chains attached to the rebaudioside D by hydrogen bonding. The chain formation prevents agglomeration of the co-precipitate and provides stability to the co-precipitate. In some embodiments, the co-precipitate material may be spray-dried and added to an edible composition. In certain embodiments, the aqueous dispersion of precipitate material is an aqueous microdispersion. In some embodiments, the aqueous microdispersion is a 0.01% to 5.0%, 0.1% to 3.0%, or about a 1.0% microdispersion of precipitate material comprising a hydrophilic polymer and a low solubility material. The percentage of precipitate material in the aqueous microdispersion may be dependent on the starting amount of the low solubility material, the starting amount of the hydrophilic polymer, and the amount of solvent evaporation of both water and ethanol.

In certain embodiments, the microdispersion mean particle size is measured by optical microscopy and a particle size analyzer, such as a Horiba. The mean particle size of the precipitate material may range from 2.0 μm to 15.0 μm. In certain embodiments, the mean particle size may be within the range of 2.2 μm to 10.5 μm or within the range of 3.0 μm to 10.0 μm. Exemplary particle size data of rebaudioside D co-precipitated with various hydrophilic polymers is provided in FIG. 2. It is currently understood that the small particle size with high surface area of the co-precipitate comprising rebaudioside D and carboxymethyl cellulose is surprisingly beneficial for increasing the solubility of the rebaudioside D. It is believed that the low solubility material having a small particle size and a high surface area has an increased solubility in water. The high surface area of the low solubility material provides an increased number of locations for water molecules to interact with, so that when the low solubility material is diluted in water, the solubility of the material is increased.

Although one method to prepare an aqueous microdispersion of precipitate material comprising a hydrophilic polymer and a low solubility material has been described above, it is to be understood that other methods and processing techniques for preparing a microdispersion of precipitate material may also be utilized. Other methods of producing a microdispersion of precipitate material are possible. The subject matter defined in the appended claims is not necessarily limited to the specific features or acts described above. Rather, the specific features and methods described above are disclosed as exemplary forms of implementing the claims. In addition, unless stated otherwise, all percentages recited in the description, disclosure and the appended claims are percent by weight of the fully formulated microdispersion, sweetener, syrup, component, food or beverage product, composition, solution and the like unless otherwise stated.

In certain embodiments, the aqueous microdispersion comprising a precipitate material of a hydrophilic polymer and a low solubility material may be incorporated into an edible composition, such as, for example, a sweetener composition, a syrup, a beverage concentrate, a food product, a beverage product, etc. In alternative embodiments, the aqueous microdispersion comprising a precipitate material is spray-dried and the spray-dried precipitate is incorporated into an edible composition. As used here and in the appended claims, the term “sweetener composition” is an edible composition suitable for consumption in solutions, components, food or beverage products, and compositions included in the disclosure and which is capable of providing sweetness.

In certain embodiments of the edible compositions disclosed here, the sweetener composition may comprise a microdispersion of precipitate material comprising a hydrophilic polymer and a low solubility material, for example, a microdispersion of a precipitate material comprising carboxymethyl cellulose and a sweetener, such as, rebaudioside D.

In certain embodiments of the edible compositions disclosed here, a microdispersion of precipitate material comprising a hydrophilic polymer and a low solubility material, such as rebaudioside D, is used as a sweetening composition, either alone or in conjunction with other sweetening compositions or sweeteners. Other sweeteners or combinations of sweeteners suitable for use in combination with rebaudioside D may be selected for the desired nutritional characteristics, taste profile, mouthfeel and/or other organoleptic factors. Non-nutritive sweeteners suitable for use in at least certain embodiments include, but are not limited to, peptide based sweeteners, e.g., aspartame, neotame, and alitame, and non-peptide based sweeteners, for example, sodium saccharin, calcium saccharin, acesulfame (including, but not limited to acesulfame potassium), cyclamate (including, but not limited to sodium cyclamate and/or calcium cyclamate), and sucralose, sorbitol, mannitol, xylitol, glycyrrhizin, neohesperidin dihydrochalcone, D-tagatose, erythritol, meso-erythritol, malitol, maltose, lactose, fructo-oligosaccharides, Lo Han Guo (“LHG”), steviol glycosides, e.g., steviosides and rebaudiosides other than rebaudioside D (including, but not limited to e.g., rebaudioside A, rebaudioside B, rebaudioside C, rebaudioside E, and rebaudioside F), and other dipeptides (e.g. neotame), saccharin, xylose, arabinose, isomalt, lactitol, maltitol, trehalose, and ribose, and protein sweeteners such as thaumatin, monellin, monatin, brazzein, L-alanine and glycine, related compounds and mixtures of any of them. It will be within the ability of those skilled in the art, given the benefit of this disclosure, to select suitable additional or alternative sweeteners for use in various embodiments of the edible compositions disclosed here.

As used here and in the appended claims, the term “edible composition” means a food or beverage product or an ingredient of a food or beverage product suitable for human or animal consumption. Exemplary beverage products include, but are not limited to, any ingredient or any combination of ingredients, or any substance or any combinations of substances, that can be used or prepared for use as a beverage for a mammal and includes, but is not limited to, ready to drink liquid formulations, beverage concentrates, syrups, powders and the like. Exemplary beverage products include, but are not limited to, carbonated and non-carbonated beverages, fountain beverages, frozen ready-to-drink beverages, frozen carbonated beverages, beverage concentrates, powdered concentrates, coffee beverages, tea beverages, dairy beverages, flavored waters, enhanced waters, fruit juices, fruit juice-flavored drinks, fruit-flavored drinks, sports drinks, soy drinks, hydration drinks, energy drinks, fortified/enhanced water drinks, vegetable drinks, grain-based drinks, malt beverages, fermented drinks, yogurt drinks, kefir, alcoholic beverages, and mixtures of any of them. Exemplary fruit juice sources include citrus fruit, e.g. orange, grapefruit, lemon and lime, berry, e.g. cranberry, raspberry, blackberry, blueberry and strawberry, apple, watermelon, grape, pineapple, prune, pear, peach, cherry, mango, and pomegranate. Beverage products further include, e.g., full calorie drinks/beverages and reduced-calorie (e.g., light, diet, zero calorie) drinks/beverages. Beverage products include bottle, can, and carton products and fountain syrup applications.

In certain embodiments, additional ingredients may be added to the edible compositions disclosed here. These additional ingredients may also be referred to as food or beverage ingredients and include, but are not limited to acidulants, colorants, flavorants, minerals, vitamins, fruit juices, fruit flavors, or other fruit products, other taste modifiers, e.g., tastents, masking agents and the like, flavor enhancers, and/or carbonation, any of which typically can be added to various sweeteners, solutions, components, or food or beverage products to vary the taste, mouthfeel, nutritional characteristics, etc. Exemplary flavorants which may be suitable as beverage ingredients for at least certain beverage products in accordance with this disclosure include cola flavor, tea flavor, citrus flavor, berry flavor, spice flavor and others. Carbonation in the form of carbon dioxide may be added for effervescence. Preservatives can be added if desired, depending upon the other ingredients, production technique, desired shelf life, etc. Optionally, caffeine can be added. The beverage products of the present invention may also contain other ingredients including, without limitation, vitamins, natural buffering agents, e.g., the sodium and potassium salts of citric, tartaric, and lactic acids, natural preservatives, e.g., nisin, cinnamic acid, etc., natural salts, thickeners, and natural anti-foaming agents. Additional and alternative suitable ingredients will be recognized by those skilled in the art given the benefit of this disclosure.

The terms “beverage concentrate,” and “syrup” are used interchangeably throughout this disclosure. At least certain embodiments of the beverage products contemplated are prepared with an initial volume of water to which additional beverage ingredients are added. Full strength beverage products can be formed from the beverage concentrate by adding further volumes of water to the concentrate (also known in the beverage industry as “throwing”). Typically, for example, full strength beverage products can be prepared from the concentrates by combining approximately 1 part concentrate with between approximately 3 to approximately 7 parts water. In certain embodiments the full strength beverage product is prepared by combining 1 part concentrate with 5 parts water. In certain embodiments the additional water used to form the full strength beverages is carbonated water. In certain other embodiments, a full strength beverage is directly prepared without the formation of a concentrate and subsequent dilution.

As used here and in the appended claims, “sweetened syrup” is defined as syrup that possesses sweetness, and comprises at least one or more sweeteners. In certain embodiments of the sweetened syrups disclosed here, the sweetener comprises an aqueous microdispersion of precipitate material comprising a hydrophilic polymer and a low solubility material, such as, for example, rebaudioside D.

It should be understood that certain embodiments of the edible compositions and methods in accordance with this disclosure may have any of numerous specific formulations or constitutions. For example, the method for forming syrup may vary to a certain extent, depending upon such factors as the end product's intended market segment, its desired nutritional characteristics, flavor profile and the like. For example, it will be an option to add further ingredients to the formulation of a particular solution or beverage product comprising at least some amount of the syrup. Additional (i.e., more and/or other) sweeteners may be added, flavorings, electrolytes, vitamins, fruit juices or other fruit products, tastents, masking agents and the like, and/or flavor enhancers, typically can be added to any such solutions or products to vary the taste, mouthfeel, nutritional characteristics, etc. Exemplary flavorings which may be suitable for at least certain solutions and products in accordance with this disclosure include cola flavoring, citrus flavoring, spice flavorings and others. Additional and alternative suitable ingredients will be recognized by those skilled in the art given the benefit of this disclosure.

Water is a basic food and beverage ingredient used in the edible compositions and methods disclosed here. Water may comprise a certain concentration of dissolved compound, and typically acts as the vehicle or liquid portion in which the remaining ingredients are dissolved, emulsified, suspended or dispersed. Purified water can be used in the manufacture of certain embodiments of the beverage product, and water of a standard beverage quality can be employed in order not to adversely affect beverage product taste, odor, or appearance. The water typically will be clear, colorless, and free from objectionable minerals, tastes and odors, free from organic matter, low in alkalinity and of acceptable microbiological quality based on industry and government standards applicable at the time of producing the beverage. Water suitable for certain embodiments included in this disclosure may also be carbonated.

Certain embodiments of the edible compositions disclosed here comprising an aqueous microdispersion of a precipitate material comprising hydrophilic polymer and low solubility material, such as rebaudioside D, may also include one or more acids. An acidulant can serve any of one or more functions, including, for example, lending tartness to the taste of a beverage product, enhancing palatability, increasing thirst quenching effect, modifying sweetness and acting as a mild preservative. Suitable acids are known and will be apparent to those skilled in the art given the benefit of this disclosure. Exemplary acids suitable for use in certain embodiments of the beverage products disclosed here include, but are not limited to, phosphoric acid, citric acid, malic acid, tartaric acid, lactic acid, ascorbic acid, fumaric acid, gluconic acid, succinic acid, maleic acid, adipic acid and mixtures of any of them. The acid can be used in solution form, for example, and in an amount sufficient to provide the desired pH of the beverage product. Typically, for example, the one or more acids of the acidulant are used in amount, collectively, of from about 0.01% to about 0.5% by weight of the beverage, e.g., from about 0.05% to about 0.25% by weight of the beverage, depending upon the acidulant used, desired pH, other ingredients used, etc. The pH of at least certain embodiments of the beverage products disclosed here can be a value within the range of from at least 2.0 to about 5.0. The acid in certain embodiments enhances beverage product flavor. Too much acid can impair the beverage product flavor and result in sourness or other off-taste, while too little acid can make the beverage product taste flat. The particular acid or acids chosen and the amount used will depend, in part, on the other ingredients, the desired shelf life of the beverage product, as well as effects on the beverage product pH, titratable acidity, and taste. It will be within the ability of those skilled in the art, given the benefit of this disclosure, to select a suitable acid or combination of acids and the amounts of such acids for the acidulant component of any particular embodiment of the beverage products disclosed here.

Certain embodiments of the edible compositions disclosed here may also contain small amounts of buffering agents to adjust pH. Such agents include, but are not limited to, e.g., the sodium and potassium salts of citric, tartaric, and lactic acids. The amount included will depend on the type of buffering agents and on the degree to which the pH is to be adjusted.

The edible compositions disclosed here may optionally contain one or more additional flavor compositions, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. Also included within the term “fruit flavor” are synthetically prepared flavors made to simulate fruit flavors derived from natural sources. Examples of suitable fruit sources include whole fruits or portions thereof, fruit juice, fruit juice concentrates, fruit purees and blends thereof, dried fruit powders, dried fruit juice powders, freeze dried fruit juices, powders and purees and the like.

Exemplary fruit flavors include the citrus flavors, e.g., orange, mandarin orange, tangerine, tangelo, pomelo, lemon, lime and grapefruit, and such flavors as apple, grape, cherry, and pineapple flavors and the like, and any combination thereof. In certain embodiments the edible compositions disclosed here comprise a fruit flavor component, e.g., juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such botanical flavors include cola flavors, tea flavors, coffee, cocoa, hazelnut, almond, other nut flavors, and mixtures thereof. The flavor component can further comprise a blend of the above-mentioned flavors. In certain embodiments of the edible compositions described here, a cola flavor component and/or a tea flavor component is used. The particular amount of the flavor component useful for imparting flavor characteristics to the solution, food or beverages product, or composition will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Other flavorings suitable for use in at least certain embodiments of the edible compositions disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain embodiments will be apparent to those skilled in the art given the benefit of this disclosure. Flavorings can be many forms, including, but not limited to an extract, oleoresin, juice concentrate, bottler's base, or other forms known in the art.

The one or more flavorings can be used in the form of an emulsion. A flavoring emulsion can be prepared by mixing some or all of the flavorings together, optionally together with food or beverage ingredients, and an emulsifying agent. The emulsifying agent may be added with or after the flavorings mixed together. In certain embodiments the emulsifying agent is water-soluble. Exemplary suitable emulsifying agents include, but are not limited to gum acacia, modified starch, carboxymethyl cellulose, gum tragacanth, gum ghatti and other suitable gums. Additional suitable emulsifying agents will be apparent to those skilled in the art, given the benefit of this disclosure.

Weighting agents, which can also act as clouding agents, are typically used to keep emulsion droplets dispersed in a beverage product. Examples of such weighting agents include, but are not limited to brominated vegetable oils (BVOs), rosin esters, sucrose acetate isobutyrate (SAIB), and, in particular, ester gums. Any weighting agent that is commercially available can be used in beverage products disclosed here. Besides weighting agents, emulsifiers and emulsion stabilizers can be used to stabilize the flavor emulsion droplets. Examples of such emulsifiers and emulsion stabilizers include, but are not limited to gums, pectins, cellulose, polysorbates, sorbitan esters and propylene glycol alginates.

Carbon dioxide is used to provide effervescence to certain embodiments of the sweeteners, syrups, solutions, food or beverage products, components, and compositions disclosed here. Any of the techniques and carbonating equipment known in the art for carbonating food or beverage products can be employed. Carbon dioxide can enhance the food or beverage product taste and appearance and can aid in safeguarding the beverage product purity by inhibiting and destroying objectionable bacteria. In certain embodiments, for example, the beverage product has a CO₂ level up to about 7.0 volumes carbon dioxide. Typical embodiments may have, for example, from about 0.5 to 5.0 volumes of carbon dioxide. As used here and in the appended claims, one volume of carbon dioxide at standard temperature and pressure (STP) is defined as 0.05806 g/oz (0.00197 g/ml). A volume of gas occupies the same space as does the water by which it is absorbed. The carbon dioxide content can be selected by those skilled in the art based on the desired level of effervescence and the impact of the carbon dioxide on the taste or mouthfeel of the beverage product and the carbonation may be natural or synthetic.

Optionally, caffeine may be added to various embodiments of the sweeteners, syrups, solutions, food or beverage products, components, and compositions disclosed here. The amount of caffeine added is determined by the desired solution, food or beverage product, or composition properties, as well as any applicable regulatory provisions of the country where the solution, food or beverage product, or composition is to be marketed, etc. The caffeine must be of purity acceptable for use in foods and beverage products. The caffeine can be natural (e.g., from kola, cocoa nuts, coffee and/or tea) or synthetic in origin. The amount of caffeine can be from about 0.002% to about 0.05% by weight of the single strength beverage. In certain embodiments, the amount of caffeine is from about 0.005% to about 0.02%. In certain embodiments caffeine is included at a level of 0.02% or less by weight of the beverage product. For beverage concentrates or syrups, the caffeine level can be from about 0.006% to about 0.15%. Caffeine levels can be higher, for example, if flavored coffees which have not been decaffeinated are used since these materials contain caffeine naturally.

Examples of nutritional supplement ingredients suitable for the edible compositions disclosed here are known to those of ordinary skill in the art and include, without limitation, vitamins, minerals, herbs or botanicals, amino acids, or essential fatty acids or enzymes, proteases, tissues, organs, glands or portions thereof. Vitamins include, but are not limited to, vitamin A, vitamin D, vitamin E (tocopherol), vitamin C (ascorbic acid), vitamin B₁ (thiamine), vitamin B₂ (riboflavin), vitamin B₃ (niacin), vitamin B₅ (pantothenic acid), vitamin B₆ (pyridoxine), vitamin B₇ (biotin), vitamin B₉ (folic acid), vitamin B₁₂ (cyanocobalamin), vitamin K (naphthoquinone), vitamin D (D₁ (molecular compound of ergocalciferol with lumisterol, 1:1); D₂ (ergocalciferol or calciferol); D₃ (cholecalciferol); D₄ (dihydrotachysterol); D₅ (sitocalciferol)), and combinations thereof. Supplements are typically present in amounts generally accepted under good manufacturing practices and are typically present in amounts between about 1% to about 100% RDV, where such RDV are established. In certain embodiments, the nutritional supplement ingredient(s) may be present in an amount of from about 5% to about 20% RDV, where established.

Certain edible compositions disclosed here can optionally further include one or more colorants. As used herein, the “colorant” is intended to mean any compound that imparts color, which includes, but is not limited to natural pigments, synthetic pigment, color additives and mixtures thereof. Natural and artificial colors may be used. One or more FD&C dyes (e.g., yellow #5, blue #2, red #40) can be used to color solutions, food or beverage products, or compositions disclosed here. A mixture of FD&C dyes in combination with other conventional food and food colorants may be used. Examples of other coloring agents, include, but are not limited to natural agents, fruit and vegetable juices and/or powders, caramel color, riboflavin, carotenoids (for example, beta-carotene), tumeric, and lycopenes. The exact amount of coloring agent used will vary, depending on the agents used and the intensity desired in the finished product. Generally, if utilized, the coloring agent should be present at a level of from about 0.0001% to about 0.5%, from about 0.001% to about 0.1%, or from about 0.004% to about 0.1%, by weight or volume of the composition.

Preservatives may be used in at least certain embodiments of the edible compositions disclosed here. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the solution, food or beverage product, or composition at any suitable time during production, e.g., in some cases prior to the addition of the sweetener. As used here, the terms “preservation system” or “preservatives” include all suitable preservatives approved for use in food and beverage products, including, without limitation, such known chemical preservatives as benzoates, e.g., sodium, calcium, and potassium benzoate, sorbates, e.g., sodium sorbate, calcium sorbate, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and any combination thereof.

Preservatives can be used in amounts not exceeding mandated maximum levels under applicable laws and regulations. The level of preservative used typically is adjusted according to the planned final product pH, as well as an evaluation of the microbiological spoilage potential of the particular edible composition formulation. In certain embodiments of the edible composition disclose here, the maximum level employed typically is about 0.05% by weight of the edible composition. It will be within the ability of those skilled in the art, given the benefit of this disclosure, to select a suitable preservative or combination of preservatives for edible compositions according to this disclosure.

Other methods of edible composition preservation suitable for at least certain embodiments disclosed here include, e.g., heat treatment or thermal processing steps, such as hot filling, high temperature short time (HTST), ultra high temperature processing (UHT), aseptic, and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate.

In certain embodiments, the edible compositions disclosed here may be provided in the form of juice. Juices can be employed in the form of a concentrate, puree, single-strength juice, or other suitable forms. The term “juice” as used here includes fruit and/or or vegetable juice, as well as concentrates, purees, milks, and other forms. The juice may be, for example, a single-strength juice. Multiple different fruit and/or vegetable juices can be combined, optionally along with other flavorings, to generate a beverage product having the desired flavor. Examples of suitable juice sources include, but are not limited to, plum, prune, fig, pineapple, peach, banana, apple, pear, guava, apricot, watermelon, coconut, olive, kiwi, quince, buckthorn, passion fruit, rowan, pomegranate, persimmon, mango, rhubarb, papaya, litchi, lemon, orange, lime, tangerine, mandarin orange, tangelo, pomelo, grapefruit, Barbados cherry (acerola cherry), bearberry, blackberry, blueberry, boysenberry, cherry, choke cherry, cloudberry, cranberry, current, date, dewberry, elderberry, grape, gooseberry, huckleberry, loganberry, olallieberry, mulberry, raisin, plains berry, prairie berry, raspberry, Saskatoon berry, salmonberry, Seabuckthorn berry, sloe berry, strawberry, thimbleberry, Thornberry, wineberry, whortleberry and the like. Numerous additional and alternative juices suitable for use in at least certain embodiments will be apparent to those skilled in the art given the benefit of this disclosure. The particular amount of the juice useful for imparting flavor characteristics to the beverages product will depend upon the juice(s) selected, the flavor impression desired, and the form of the juice component. Those skilled in the art, given the benefit of this disclosure, will be readily able to determine the amount of any particular juice(s) used to achieve the desired flavor impression.

Exemplary food products include, but are not limited to any ingredient or any combination of ingredients, or any substance or any combination of substances, that can be used or prepared for use as food for a mammal and includes, but is not limited to, substances that may be used in the preparation of food (such as frying oils) or food additives. As used here and in the appended claims, the term “food ingredients” may include, but are not limited to, acidulants, natural and artificial gums, pharmaceutical preparations, beverages (e.g., soft drinks, carbonated beverages, ready to mix beverages, etc.), infant formula, infused foods (e.g. fruits and vegetables), sauces, condiments, salad dressings, fruit juices, syrups, desserts (e.g., puddings, gelatin, icings and fillings, baked goods and frozen desserts such as ice creams and sherbets), soft frozen products (e.g., soft frozen creams, soft frozen ice creams and yogurts, soft frozen toppings such as dairy or non-dairy whipped toppings), confections, toothpaste, mouthwash, chewing gum, oils and emulsified products (e.g., shortening, margarine, mayonnaise, butter, cooking oil, and salad dressings) and intermediate moisture foods (e.g., rice and dog foods). Furthermore, food ingredients described herein can also be ingested as an additive or supplement contained in foods and drinks. These can optionally be formulated together with a nutritional substance, such as any of various vitamins and minerals. The food ingredients may also optionally be incorporated into substantially liquid compositions, such as, e.g., nutrient drinks, soymilks and soups; substantially solid compositions, and gelatins or used in the form of a powder to be incorporated into various foods.

Those of ordinary skill in the art will understand that, for convenience, some ingredients are described here in certain cases by reference to the original form of the ingredient in which it is added to the edible compositions disclosed here. Such original form may differ from the form in which the ingredient is found in the finished edible composition. Thus, for example, sucrose and liquid sucrose would typically be substantially homogenously dissolved and dispersed in a solution. Likewise, other ingredients identified as a solid, concentrate (e.g., juice concentrate), etc. would typically be homogenously dispersed throughout the edible composition, rather than remaining in their original form. Thus, reference to the form of an ingredient of an edible composition should not be taken as a limitation on the form of the ingredient in the edible composition, but rather as a convenient means of describing the ingredient as an isolated component of the edible composition.

### EXAMPLES

### Example 1

1 g rebaudioside D was dissolved in 100 g of 50% ethanol in water, at 65° C., on a stir plate for 10 minutes. The solution was left to cool under vigorous stirring at room temperature, after reaching room temperature it was added with stirring to 50 g of 1% solution of carboxymethyl cellulose. The remaining ethanol was removed by evaporation overnight and the final 1% rebaudioside D microdispersion was analyzed for particle size by optical microscopy and a Horiba particle size analyzer. The rebaudioside D co-precipitated with the carboxymethyl cellulose as seen in FIG. 3.

### Comparative Example 1

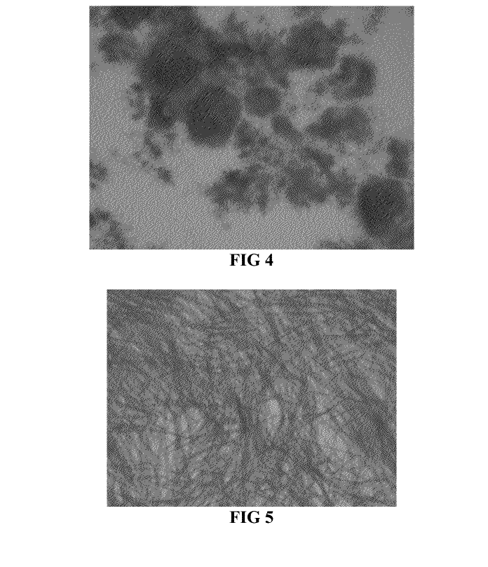

A microdispersion of rebaudioside D precipitated in carboxymethyl cellulose was compared to a microdispersion of rebaudioside D crystalline hydrates precipitated from 50% water/ethanol but with no carboxymethyl cellulose or other polymers. The rebaudioside D crystalline hydrates precipitated with water/ethanol formed large rebaudioside D aggregates as seen in FIG. 4.

### Example 2

1 g rebaudioside D was dissolved in 100 g of a 50% ethanol in water, at 65° C., on a stir plate for 10 minutes. The solution was left to cool under vigorous stirring at room temperature after reaching room temperature it was added with stirring to 50 g of 1% solution poly(vinyl alcohol). The remaining ethanol was removed by evaporation overnight and the final 1% rebaudioside D microdispersion was analyzed for particle size by optical microscopy and using a Horiba particle size analyzer. The rebaudioside D co-precipitated with the poly(vinyl alcohol) as can be seen in FIG. 5.

### COMPARATIVE EXAMPLES

Microdispersions having rebaudioside D precipitated in a variety of polymers were compared based on their particle size. Microdispersions were prepared utilizing 1% CMC, 1% PVA, 1% PEG 6000, 1% PEG 1500, 1% HPMC, 0.5% CMC, 0.5% CMC, 4% bCD, 0.5% PVP, 0.5% PVA, 2% CMC, 0.1% Tween (pH 6), and rebaudioside D with no polymer. As can be seen in FIG. 2, the rebaudioside D precipitated without a polymer has a much larger aggregate size than the precipitates of rebaudioside D with a hydrophilic polymer.

### Example 3

5 g rebaudioside D was dissolved in 500 g of a 50% ethanol in water, at 65° C., on a stir plate for 10 min. The solution was left to cool under vigorous stirring at room temperature after reaching room temperature it was added with stirring to 800 g of 2% solution CMC and 0.1% Tween 60. The microdispersion was sprayed-dry using a Buchi spray drier in the lab. A schematic of the drying process can be seen in FIG. 1. The rebaudioside D co-precipitated with the CMC.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc. Although the subject matter has been described in language specific to sweeteners, solutions, components, products, compositions and methodological acts, it is to be understood that the subject matter defined in the appended claims is not necessarily limited to the specific sweeteners, solutions, components, products, compositions or acts described above. Rather, the specific sweeteners, solutions, components, products, compositions, and acts described above are disclosed as example forms of implementing the inventive sweeteners, solutions, components, products, compositions and methods defined by the following claims.

I claim:

1. An edible aqueous microdispersion comprising a co-precipitate material of a hydrophilic polymer and a low solubility food ingredient material, wherein:
the co-precipitate material is present in the aqueous microdispersion at a concentration sufficient to provide an effective concentration of the low solubility food ingredient material higher than the normal solubility of the low solubility food ingredient material in water at 70° F.; and
the co-precipitate material has a perceptible taste in the aqueous microdispersion.

2. The edible aqueous microdispersion of claim 1, wherein the low solubility food ingredient material comprises rebaudioside D.

3. The edible aqueous microdispersion of claim 2, wherein the low solubility food ingredient material further comprises rebaudioside A, rebaudioside B, rebaudioside C, rebaudioside E, rebaudioside F, mogroside, stevioside, steviol glycoside, Lo Han Guo, or a combination of any of them.

4. The edible aqueous microdispersion of claim 1, wherein the low solubility food ingredient material comprises a potent sweetener.

5. The edible aqueous microdispersion of claim 1, wherein the low solubility food ingredient material comprises a nutritive sweetener.

6. The edible aqueous microdispersion of claim 1, wherein the low solubility food ingredient material comprises a natural sweetener.

7. The edible aqueous microdispersion of claim 1, further comprising a flavor, a flavonoid, a flavonol, a flavanone, a flavone, an isoflavone, a stibene, a polyphenol, a hydroxybenzoic acid, an alkaloid, an anthocyanin, a coumarin, a chromone, a chalcone, a bioactive, a taste modifier or a combination of any of them.

8. The edible aqueous microdispersion of claim 1, wherein the hydrophilic polymer comprises starch, amylose, amylopectin, protein, collagen, casein, carboxymethyl cellulose, alpha-lactoglobulin, beta-lactoglobulin, alpha-lactalbumin, gelatin, mucin, bromelain, polysaccharide, gum, alginate, carrageenan, gum arabic, locus bean gum, guar gum, pectin, maltodextrin, xanthan gum, or a combination of any of them.

9. The edible aqueous microdispersion of claim 1, wherein the low solubility food ingredient material comprises rebaudioside D and the hydrophilic polymer comprises carboxymethyl cellulose.

10. The edible aqueous microdispersion of claim 1, wherein the low solubility food ingredient material has a water solubility value of 1 part low solubility food ingredient material to 100-1,000 parts of a solvent.

11. An edible composition comprising the edible aqueous microdispersion of claim 1.

12. The edible composition of claim 11, wherein the edible composition is a sweetener.

13. The edible composition of claim 11, wherein the edible composition is a syrup.

14. The edible composition of claim 11, wherein the edible composition is a beverage.

15. A edible composition comprising a sweetener, wherein the edible composition is prepared by a method comprising:
providing a solution of a sweetener comprising as solvent a mixture of at least water and an alcohol;
providing a solution of a water-soluble hydrophilic polymer;
combining the solution of the sweetener and the solution of the hydrophilic polymer to form a hydrophilic polymer and sweetener solution;
allowing the sweetener to co-precipitate with the hydrophilic polymer;
adding the co-precipitate to an edible composition.

16. The edible composition of claim 15, wherein the sweetener comprises a first sweetener compound having a normal solubility value of 1 part sweetener to 100-1,000 parts of a solvent.

17. The edible composition of claim 16, wherein the first sweetener compound comprises a sweetening amount of rebaudioside D.

18. The edible composition of claim 16, wherein the first sweetener compound is a potent sweetener.

19. The edible composition of claim 15, wherein the co-precipitate is spray-dried prior to adding to an edible composition.

20. The edible composition of claim 15, wherein the sweetener co-precipitates within the hydrophilic polymer.

21. The edible composition of claim 15, wherein the sweetener further comprises a sweetening amount of rebaudioside A, rebaudioside B, rebaudioside C, rebaudioside E, rebaudioside F, mogroside, stevioside, steviol glycoside, Lo Han Guo, or a combination of any of them.

22. The edible composition of claim 15 further comprises a flavor, a flavonoid, a flavonol, a flavanone, a flavone, an isoflavone, a stibene, a polyphenol, a hydroxybenzoic acid, an alkaloid, an anthocyanin, a coumarin, a chromone, a chalcone, a bioactive, a taste modifier or a combination of any of them.

23. The edible composition of claim 15, wherein the edible composition further comprises an additional sweetener different from the sweetener compound of the co-precipitate material, and the additional sweetener contributes perceptible sweetness to the edible composition.

24. The edible composition of claim 23, wherein the additional sweetener is a nutritive sweetener.

25. The edible composition of claim 23, wherein the additional sweetener is a natural sweetener.

26. A method for forming an aqueous microdispersion comprising a co-precipitate material of a hydrophilic polymer and a low solubility food ingredient material comprising:
providing a solution of a low solubility food ingredient material;
providing a solution of a hydrophilic polymer;
combining the solution of the low solubility food ingredient material and the solution of the hydrophilic polymer to form a hydrophilic polymer and low solubility food ingredient material solution;
allowing the low solubility food ingredient material to co-precipitate with the hydrophilic polymer forming a co-precipitate material.

27. The method of claim 26, wherein the low solubility food ingredient material comprises a natural low solubility material.

28. The method of claim 26, wherein the low solubility food ingredient material comprises rebaudioside D.

29. The method of claim 26, wherein the low solubility food ingredient material further comprises rebaudioside A, rebaudioside B, rebaudioside C, rebaudioside E, rebaudioside F, mogroside, stevioside, steviol glycoside, Lo Han Guo, or a combination of any of them.

30. The method of claim 26 further comprising a flavor, a flavonoid, a flavonol, a flavanone, a flavone, an isoflavone, a stibene, a polyphenol, a hydroxybenzoic acid, an alkaloid, an anthocyanin, a coumarin, a chromone, a chalcone, a bioactive, a taste modifier or a combination of any of them.

31. The method of claim 26, wherein the hydrophilic polymer comprises a natural hydrophilic polymer.

32. The method of claim 26, wherein the hydrophilic polymer comprises starch, amylose, amylopectin, protein, collagen, casein, carboxymethyl cellulose, alpha-lactoglobulin, beta-lactoglobulin, alpha-lactalbumin, gelatin, mucin, bromelain, polysaccharide, gum, alginate, carrageenan, gum arabic, locus bean gum, guar gum, pectin, maltodextrin, xanthan gum, or a combination of any of them.

33. The method of claim 26, wherein the solution of a low solubility food ingredient material comprises a solvent comprising at least 50% ethanol.

34. The method of claim 26, wherein the aqueous microdispersion comprises 0.01% to 5.0% of a co-precipitate material.

35. The method of claim 26, wherein the co-precipitate material mean particle size is from 2.0 μm to 15 μm.

36. An aqueous microdispersion comprising a co-precipitate material of a hydrophilic polymer and a low solubility food ingredient material, wherein the aqueous microdispersion is prepared by a method comprising:
providing a solution of a low solubility food ingredient material comprising as solvent a mixture of at least water and an alcohol;
providing a solution of a water-soluble hydrophilic polymer;
combining the solution of the low solubility food ingredient material and the solution of the hydrophilic polymer to form a hydrophilic polymer and low solubility food ingredient material solution;
allowing the low solubility food ingredient material to co-precipitate with the hydrophilic polymer forming a co-precipitate material.

37. The microdispersion of claim 36, wherein the low solubility food ingredient material comprises rebaudioside D and the hydrophilic polymer comprises carboxymethyl cellulose.

38. The microdispersion of claim 36, wherein the co-precipitate material has a solubility value of 1 part co-precipitate material to 100-1,000 parts of a solvent.

39. A method for forming an aqueous microdispersion of rebaudioside D comprising:
providing a solution of rebaudioside D comprising as solvent a mixture of water and at least 50% alcohol;
providing a solution of carboxymethyl cellulose;
combining the solution of rebaudioside D and the solution of carboxymethyl cellulose to form a solution of rebaudioside D and carboxymethyl cellulose;
allowing the rebaudioside D to co-precipitate with the carboxymethyl cellulose.

40. A precipitate material comprising a hydrophilic polymer and a low solubility food ingredient material, wherein:
the low solubility food ingredient material has a normal solubility value of 1 part low solubility food ingredient material to 100-1,000 parts of a solvent.

41. The precipitate material of claim 40, wherein the low solubility food ingredient material is a potent sweetener.

42. The precipitate material of claim 40, wherein the low solubility food ingredient material comprises rebaudidoside D and the hydrophilic polymer comprises carboxymethylcellulose.

43. The precipitate material of claim 40, wherein the precipitate material is a co-precipitate material.
